(19) United States
(12) Patent Application Publication
(10) Pub. No.: US 2025/0232166 A1
(43) Pub. Date: Jul. 17, 2025

(54) INFORMATION PROCESSING DEVICE

(71) Applicant: TDK CORPORATION, Tokyo (JP)

(72) Inventors: Eiji SUZUKI, Tokyo (JP); Tomoyuki SASAKI, Tokyo (JP)

(73) Assignee: TDK CORPORATION, Tokyo (JP)

(21) Appl. No.: 18/698,226

(22) PCT Filed: Oct. 15, 2021
(86) PCT No.: PCT/JP2021/038325

§ 371 Date: Apr. 3, 2024

(51) Int. Cl. G06N 3/065

(52) U.S. Cl. CPC G06N 3/065

(57) ABSTRACT

An information processing device includes an input layer, a reservoir layer, an output layer, an evaluation circuit, and an adjustment circuit. The reservoir layer is connected to the input layer and configured to generate a feature space including information of a first signal input from the input layer. The output layer is connected to the reservoir layer and configured to apply a connection weight to a second signal which is output from the reservoir layer. The evaluation circuit is configured to calculate a distribution of connection weights in the output layer and to evaluate whether the distribution of connection weights is a prescribed distribution. The adjustment circuit is configured to change adjustment parameters for adjusting the first signal when the distribution of connection weights is not the prescribed distribution.

### TECHNICAL FIELD

The present invention relates to an information processing device.

### BACKGROUND ART

A neuromorphic device is a device that imitates the human brain using a neural network. A neuromorphic device artificially imitates a relationship between neurons and synapses in the human brain.

For example, a neuromorphic device includes nodes that are hierarchically arranged (neurons in the brain) and transmission means that connect the nodes (synapses in the brain). A neuromorphic device enhances a rate of correct answers to questions by training the transmission means (synapses). Learning is finding knowledge which is likely to be used in the future from information, and a neuromorphic device weights data that it receives.

A recurrent neural network is known as a neural network. A recurrent neural network includes recurrent connections therein and can handle nonlinear time-series data. Nonlinear time-series data is data of which a value changes with the elapse of time, and an example thereof is stock prices. A recurrent neural network can also include a nonlinear activation unit therein. A process in the activation unit can be considered as projection to a nonlinear space. By projecting data to a nonlinear space, a recurrent neural network can extract features of complex signal change of a time-series signal. A recurrent neural network can realize a recurrent process by feeding process results in neurons in a subsequent stage back to neurons in a preceding stage. A recurrent neural network can acquire rules or dominant factors in the background of time-series data by performing such a recursive process.

Reservoir computing is a kind of recurrent neural network including a recurrent connection and a nonlinear activation function (for example, Non-Patent Document 1). Reservoir computing is a neural network which has been developed as a method applied to a liquid state machine.

Reservoir computing includes a reservoir layer. A “layer” mentioned herein is a conceptual layer, and a layer which is a physical structure does not have to be formed. A reservoir layer forms a graph structure including a plurality of nonlinear nodes and recurrent connections between the nodes. In reservoir computing, a reservoir layer imitates connections between neurons in the human brain, and a state is expressed as change of an interference state.

One feature of reservoir computing is that a reservoir layer is not a learning target. Since computer resources required for learning are small, reservoir computing attracts attention as a system for handling time-series signals in the Internet of Things (IoT) or an edge.

### CITATION LIST

### Non Patent Document

### [Non Patent Document 1]

U. Ozertem, D. Erdogmus, and I. Santamaria, Detection of nonlinearly distorted signals using mutual information, European Signal Processing Conference. IEEE, 2005

### SUMMARY OF INVENTION

### Technical Problem

Accuracy of fitting an output value of reservoir computing to training data varies depending on settings of parameters. A method of systematically designing parameters of reservoir computing is not established yet.

The present invention was made in consideration of the aforementioned circumstances, and an objective thereof is to provide an information processing device with a high rate of correct answers.

### Solution to Problem

(1) According to a first aspect, there is provided an information processing device including an input layer, a reservoir layer, an output layer, an evaluation circuit, and an adjustment circuit. The reservoir layer is connected to the input layer and configured to generate a feature space including information of a first signal input from the input layer. The output layer is connected to the reservoir layer and configured to apply a connection weight to a second signal which is output from the reservoir layer. The evaluation circuit is configured to calculate a distribution of connection weights in the output layer and to evaluate whether the distribution of connection weights is a prescribed distribution. The adjustment circuit is configured to change adjustment parameters for adjusting the first signal when the distribution of connection weights is not the prescribed distribution.

(2) In the information processing device according to the aspect, the prescribed distribution may be a normal distribution.

(3) In the information processing device according to the aspect, the evaluation circuit may evaluate whether the distribution of connection weights is a prescribed distribution when a change in connection weight between before updating and after updating is less than or equal to a prescribed value at the time of updating the connection weights applied to the second signal.

(4) In the information processing device according to the aspect, the adjustment circuit may select an optimal adjustment parameter out of the changed adjustment parameters when the number of times of change of the adjustment parameters reaches a prescribed number.

(5) In the information processing device according to the aspect, the adjustment parameters may be connection weights which are multiplied by an input signal applied to the input layer.

(6) In the information processing device according to the aspect, the adjustment parameters may be filter coefficients of filters for selectively passing frequency components constituting an input signal applied to the input layer.

(7) In the information processing device according to the aspect, a distribution of the adjustment parameters may be a normal distribution.

(8) In the information processing device according to the aspect, a distribution of the adjustment parameters may be a uniform distribution.

### Advantageous Effects of Invention

The information processing device according to the aspect has a high rate of correct answers.

### BRIEF DESCRIPTION OF DRAWINGS

FIG. 1 is a conceptual diagram of an information processing device according to a first embodiment.

FIG. 2 is a diagram illustrating an example of a distribution of connection weights.

FIG. 3 is a flowchart illustrating a process flow that is performed by the information processing device according to the first embodiment.

### DESCRIPTION OF EMBODIMENTS

Hereinafter, embodiments will be described in detail with reference to the accompanying drawings. In the drawings referred to in the following description, featured constituents may be conveniently enlarged for the purpose of easy understanding of features, and dimensions, proportions, and the like of the constituents may be different from actual ones. Materials, dimensions, and the like exemplified in the following description are only examples, and the present invention is not limited thereto and can be appropriately modified within a range in which advantages of the present invention are achieved.

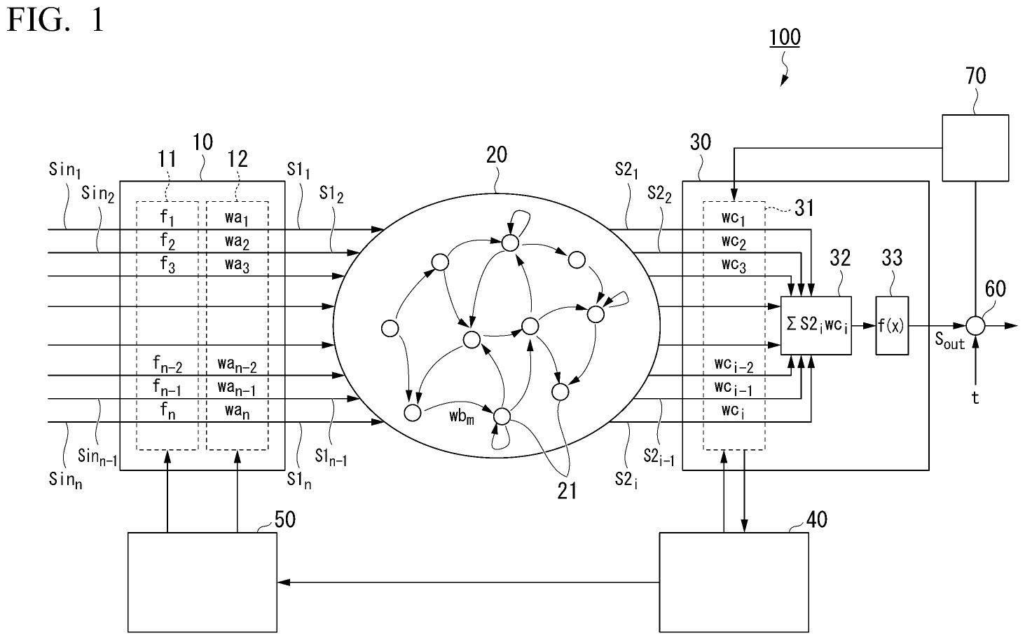

FIG. 1 is a conceptual diagram of an information processing device 100 according to a first embodiment. The information processing device 100 is a reservoir device for realizing reservoir computing. The information processing device 100 may be a device that realizes reservoir computing by software or may be a device in which the concept of reservoir computing is implemented in a physical device (hardware).

The information processing device 100 includes an input layer 10, a reservoir layer 20, an output layer 30, an evaluation circuit 40, an adjustment circuit 50, a comparison circuit 60, and an instruction circuit 70. The information processing device 100 can perform learning for enhancing a rate of correct answers to a task and an arithmetic operation (inference) of outputting a response to a task on the basis of a result of learning. The evaluation circuit 40, the adjustment circuit 50, the comparison circuit 60, and the instruction circuit 70 are used in a learning stage and are not necessary for an arithmetic operation (inference) stage.

Input signals Sin₁ to Sinₙ are input to the input layer 10. The number of input signals Sin₁ to Sinₙ is not particularly limited, and n is a natural number.

The input layer 10 is, for example, a single-layered or multi-layered perceptron. The input signals S1ₙ to Sinₙ input to the input layer 10 are converted to first signals S1₁ to S1ₙ. The number of first signals S1₁ to S1ₙ is not particularly limited, and n is a natural number. The number of first signals S1₁ to S1ₙ may be equal to or different from the number of input signals Sin₁ to Sinₙ. Signal conversion from the input signals Sin₁ to Sinₙ to the first signals S1₁ to S1ₙ is adjusted using adjustment parameters.

The input layer 10 includes, for example, a filter 11 and a bias applying unit 12. For example, the filter 11 separates the input signals Sin₁ to Sinₙ into a signal and noise. A ratio between the signal and the noise is determined, for example, by filter coefficients f₁ to fₙ. The filter coefficients f₁ to fₙ are one type of adjustment parameters. The filter 11 is provided, for example, for each of the input signals Sin₁ to Sinₙ.

The filter coefficients f₁ to fₙ for the input signals Sin₁ to Sinₙ may be the same or different from each other. The filter coefficients f₁ to fₙ may represent, for example, a distribution in which values of filter coefficients are plotted on the horizontal axis and the number of filter coefficients of a specific value is plotted on the vertical axis. The distribution of the filter coefficients f₁ to fₙ is, for example, a normal distribution, a uniform distribution, or a Laplacian distribution.

The bias applying unit 12 applies connection weights way to wan to the input signals Sin₁ to Sinₙ. The connection weights way to wan are applied to the input signals S1ₙ to Sinₙ, respectively. The bias applying unit 12 performs a product operation of multiplying the input signals Sin₁ to Sinₙ by the connection weights way to wan. The connection weights wa₁ to waₙ are a kind of adjustment parameters.

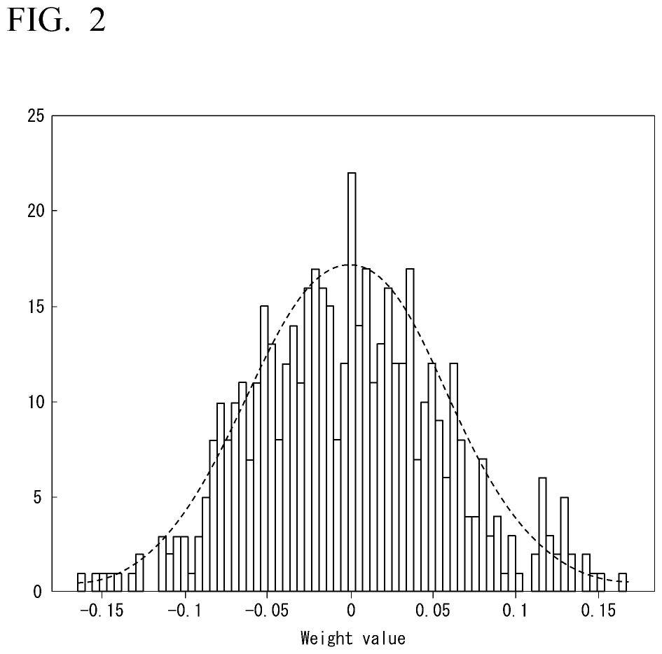

The connection weights wa₁ to waₙ may be the same or different from each other. The connection weights wa₁ to waₙ may represent, for example, a distribution in which values of the connection weights are plotted on the horizontal axis and the number of connection weights of a specific value is plotted on the vertical axis. The distribution of the connection weights way to wan is, for example, a normal distribution, a uniform distribution, or a Laplacian distribution. FIG. 2 illustrates an example of the distribution of the connection weights wa₁ to wan. FIG. 2 illustrates an example in which the distribution of the connection weights way to wan is a normal distribution.

In an example in which the concept of reservoir computing is implemented in a physical device (hardware), the connection weights way to wan are, for example, an amplitude, a frequency, or a phase of propagating waves. Waves have only to be generated due to vibration and examples thereof include an electromagnetic field, a magnetic field, a spin wave, and an elastic wave. In another example in which the concept of reservoir computing is implemented in a physical device (hardware), the connection weights wa₁ to waₙ are, for example, resistance values of variable resistors. A variable resistor is, for example, a variable-resistance element called a memristor. For example, a magnetoresistance effect element of a magnetic domain wall movement type in which a resistance value changed at a position of a magnetic domain wall is an example of a memristor.

The filter coefficients f₁ to fₙ and the connection weights wa₁ to waₙ vary in a learning stage. On the other hand, the filter coefficients f₁ to fₙ and the connection weights wa₁ to waₙ are fixed on the basis of a learning result based on tasks in the learning stage in an arithmetic operation (inference) stage.

The reservoir layer 20 includes a plurality of nodes 21. The number of nodes 21 is not particularly limited. As the number of nodes 21 increases, the expressive power of the reservoir layer 20 increases. For example, the number of nodes 21 is set to i. Here, i is an arbitrary natural number.

When the concept of reservoir computing is implemented in a physical device (hardware), each node 21 is replaced with, for example, a physical device. A physical device is, for example, a device that can convert an input signal to vibration, an electromagnetic field, a magnetic field, or a spin wave. Each node 21 is, for example, an MEMS microphone. An MEMS microphone can convert vibration of a vibration membrane to an electrical signal. Each node 21 may be, for example, a spin-torque oscillator (STO). A spin-torque oscillator can convert an electrical signal to a high-frequency signal. Each node 21 may be a Schmitt trigger circuit including a hysteresis circuit of which an output sate changes with hysteresis with change in potential of an input signal, an operational amplifier having different nonlinear response characteristics, or the like. Each node 21 may be a memristor.

A signal from each node 21 interacts with signals from neighboring nodes 21. For example, connection weights wbₘ are set between the nodes 21. The number of connection weights wbₘ corresponds to the number of combinations of connection between the nodes 21. Here, m is, for example, an arbitrary natural number. The connection weights wbₘ between the nodes 21 are fixed in principle and do not vary through learning. The connection weights wbₘ between the nodes 21 are arbitrary and may be the same or different from each other. Some of the connection weights wbₘ between a plurality of nodes 21 may vary through learning.

In an example in which the concept of reservoir computing is implemented in a physical device (hardware), the connection weights wbₘ are, for example, an amplitude, a frequency, or a phase of propagating waves. The connection weights wbₘ may be resistance values of variable resistors.

The first signals S1₁ to S1ₙ are input to the reservoir layer 20. The first signals S1₁ to S1ₙ interact with each other while propagating between a plurality of nodes 21 in the reservoir layer 20. Interaction between the first signals S1₁ to S1ₙ means that a signal propagating to a node 21 affects a signal propagating to another node 21. For example, the connection weights wbₘ are applied to the first signals S1₁ to S1ₙ at the time of propagation between the nodes 21, and the first signals S1₁ to S1ₙ changes. The reservoir layer 20 projects the input first signals S1₁ to S1ₙ to a multi-dimensional nonlinear space.

When the first signals S1₁ to S1ₙ propagate between a plurality of nodes 21, the reservoir layer 20 generates a feature space including information of the first signals S1₁ to S1ₙ input to the reservoir layer 20. In the reservoir layer 20, the input first signals S1₁ to S1ₙ are converted to second signals S2₁ to S2ᵢ. Here, i is, for example, an arbitrary natural number and may be the same as or different from n. The second signals S2₁ to S2ᵢ hold at least a part of information included in the first signals S1₁ to S1ₙ in changed forms. For example, the first signals S1₁ to S1ₙ change nonlinearly in the reservoir layer 20 and become the second signals S2₁ to S2ᵢ. By allowing the first signals S1₁ to S1ₙ to interact with each other in the reservoir layer 20, a system state of the reservoir layer 20 changes with the elapse of time.

Signals from the reservoir layer 20 are sent to the output layer 30. The second signals S2₁ to S2ᵢ output from the reservoir layer 20 are input to the output layer 30.

The output layer 30 includes, for example, a bias applying unit 31, a sum operation circuit 32, and an activation function circuit 33.

The bias applying unit 31 applies connection weights wc₁ to weᵢ to the second signals S2₁ to S2ᵢ. The connection weights wc₁ to wcᵢ are applied to the second signals S2₁ to S2i, respectively. The bias applying unit 31 performs a product operation of multiplying the second signals S2₁ to S2ᵢ by the connection weights wc₁ to wcᵢ.

The connection weights wc₁ to wcᵢ may be the same or different from each other. The connection weights wc₁ to wcᵢ represent a distribution in which values of the connection weights are plotted on the horizontal axis and the number of connection weights of a specific value is plotted on the vertical axis. The distribution of the connection weights wc₁ to wcᵢ is determined on the basis of a task. The distribution of the connection weights wc₁ to wcᵢ is, for example, a normal distribution, a uniform distribution, or a Laplacian distribution.

The connection weights wc₁ to wcᵢ vary in the learning stage. On the other hand, the connection weights wc₁ to wcᵢ are fixed on the basis of the results of learning based on a task in the learning stage in the arithmetic operation (inference) stage.

In an example in which the concept of reservoir computing is implemented in a physical device (hardware), the connection weights wc₁ to wcᵢ are, for example, an amplitude, a frequency, or a phase of propagating waves. Waves have only to be generated due to vibration and examples thereof include an electromagnetic field, a magnetic field, a spin wave, and an elastic wave. In another example in which the concept of reservoir computing is implemented in a physical device (hardware), the connection weights wc₁ to wcᵢ are, for example, resistance values of variable resistors.

The sum operation circuit 32 sums results of multiplication of the second signals S2₁ to S2ᵢ by the connection weights wc₁ to wcᵢ. The sum operation circuit 32 may sum all the results of multiplication of the second signals S2₁ to S2ᵢ by the connection weights wc₁ to wcᵢ or may sum some thereof. Results output from the sum operation circuit 32 may be one as illustrated in FIG. 1 or two or more. For example, when a signal is made to propagate using waves, waves are made to merge in the sum operation circuit 32. For example, when a signal is made to propagate using currents, lines for the currents are unified and the currents are made to merge in the sum operation circuit 32.

The activation function circuit 33 substitutes the product-sum operation results into an activation function f(x) to perform calculation. The activation function circuit 33 converts the product-sum operation results nonlinearly. The activation function circuit 33 may be skipped.

In the learning stage, an output signal Sₒᵤₜ from the output layer 30 is sent to the comparison circuit 60. In the arithmetic operation (inference) stage, the output signal Sₒᵤₜ from the output layer 30 is externally output as a response. The output signal Sₒᵤₜ is not limited to one signal. For example, when the information processing device 100 copes with a multi-class classification problem which is an application of general machine learning, the output layer 30 outputs a plurality of output signals Sₒᵤₜ corresponding to the classes.

The comparison circuit 60 compares the output signal Sₒᵤₜ with training data t. For example, the comparison circuit 60 compares the output signal Sₒᵤₜ with the training data t to obtain the mutual information. The mutual information is a quantity of mutual dependency between two probability variables. The comparison circuit 60 transmits the comparison result to the instruction circuit 70.

The instruction circuit 70 sends an instruction to the bias applying unit 31 on the basis of the comparison circuit 60. The bias applying unit 31 updates the connection weights wc₁ to wcᵢ on the basis of the instruction from the instruction circuit 70. When the connection weights wc₁ to wcᵢ change, the output signal Sₒᵤₜ from the output layer 30 changes. The instruction circuit 70 feeds back information to the bias applying unit 31 such that the mutual information between the output signal Sₒᵤₜ and the training data t is increased (maximized). The connection weights wc₁ to wcᵢ change on the basis of the fed-back data.

The evaluation circuit 40 calculates the distribution of the connection weights wc₁ to wcᵢ in the output layer 30 and evaluates whether the distribution of the connection weights wc₁ to wcᵢ is a prescribed distribution. In the learning stage, the evaluation circuit 40 may perform the evaluation whenever the connection weights wc₁ to wcᵢ are updated or may perform the evaluation on the basis of a predetermined rule. The evaluation circuit 40 may calculate differences between the connection weights wc₁ to wcᵢ before and after updating.

The distribution of the connection weights wc₁ to wcᵢ is calculated, for example, by applying a reference signal to the bias applying unit 31. For example, a switch may be provided in the middle way of the second signals S2₁ to S2ᵢ to the bias applying unit 31 and be able to convert the second signals S2₁ to S2ᵢ and the reference signal. By inputting the reference signal with a fixed value instead of the second signals S2₁ to S2ᵢ, the connection weights wc₁ to wcᵢ can be extracted. The reference signal is output from, for example, the evaluation circuit 40. For example, when the connection weights wc₁ to wcᵢ are resistance values of memristors, the resistance values (the connection weights wc₁ to wcᵢ) of the memristors may be calculated by applying a reference current to the memristors.

The adjustment circuit 50 adjusts the first signals Sli to S1ₙ on the basis of the evaluation result from the evaluation circuit 40. The adjustment circuit 50 changes the adjustment parameters of the input layer 10, for example, when the distribution of the connection weights wc₁ to wcᵢ is not a prescribed distribution. Examples of the adjustment parameters are the filter coefficients f₁ to fₙ and the connection weights wa₁ to waₙ. When the adjustment parameters are changed, the rule of signal conversion from the input signals S1ₙ to Sinₙ to the first signals S1₁ to S1ₙ changes, and the first signals S1₁ to S1ₙ change. The adjustment circuit 50 may count the number of times of change of the adjustment parameters.

The evaluation circuit 40, the adjustment circuit 50, the comparison circuit 60, and the instruction circuit 70 operate in the learning stage, but do not operate in the arithmetic operation (inference) stage.

Each of the evaluation circuit 40, the adjustment circuit 50, the comparison circuit 60, and the instruction circuit 70 includes, for example, a processor such as a CPU and a memory. Each of the evaluation circuit 40, the adjustment circuit 50, the comparison circuit 60, and the instruction circuit 70 operates by causing the processor to execute a program. The processor instructs the constituent circuits to operate, and the memory stores the program or past results.

Some or all of the operations of the circuits may be realized by hardware such as an application-specific integrated circuit (ASIC), a programmable logic device (PLD), or a field-programmable gate array (FPGA). The program may be recorded on a computer-readable recording medium. The computer-readable recording medium is, for example, a portable medium such as a flexible disk, a magneto-optical disc, a ROM, a CD-ROM, or a semiconductor storage device (for example, a solid-state drive (SSD)) or a storage device such as a hard disk or a semiconductor storage device built in a computer system. The program may be transmitted via an electrical communication line.

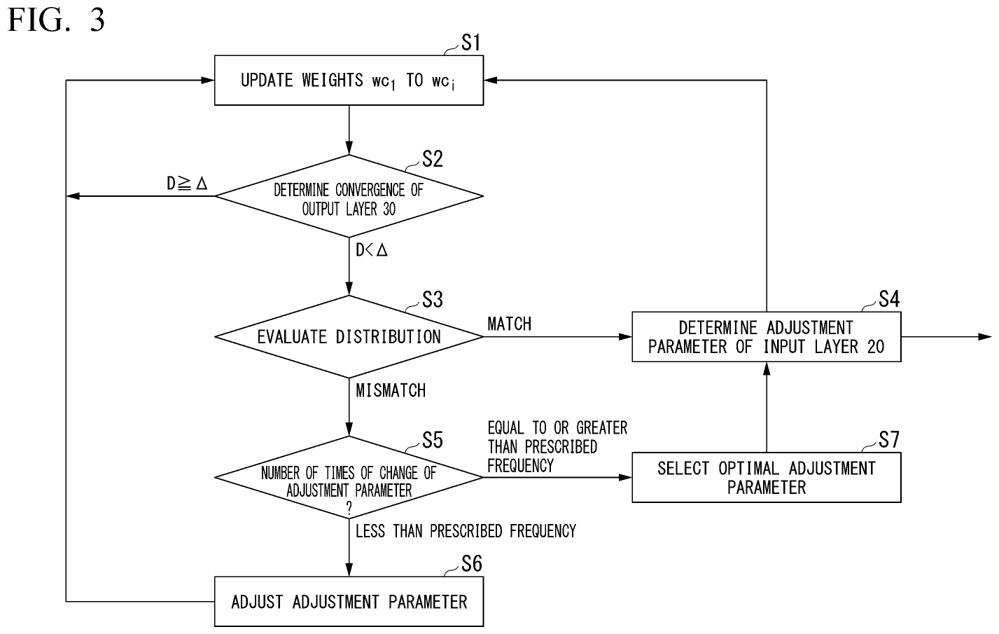

FIG. 3 is a flowchart illustrating a process flow that is performed by the information processing device 100 according to the first embodiment. The information processing device 100 operates in accordance with the flowchart illustrated in FIG. 3 in the learning stage.

The information processing device 100 outputs an output signal Sₒᵤₜ when input signals Sin₁ to Sinₙ are input thereto. The information processing device 100 compares training data t and the output signal Sₒᵤₜ while changing the connection weights wc₁ to wcᵢ of the output layer 30 and the adjustment parameters of the input layer 10. When a quantity of mutual information between the training data t and the output signal Sₒᵤₜ increases sufficiently (when the rate of correct answers to a task increases sufficiently), learning ends.

First, in a learning process, a first process S1 is performed. In the first process S1, when the comparison result from the comparison circuit 60 is not sufficient (when the rate of correct answers to the task is not sufficient), the connection weights wc₁ to wcᵢ of the output layer 30 are updated. The connection weights wc₁ to wcᵢ of the output layer 30 are changed on the basis of an instruction from the instruction circuit 70 to the bias applying unit 31. For example, the first process S1 is performed a plurality of times, and the connection weights wc₁ to wcᵢ are updated every time.

Subsequently, a second process S2 is performed. In the second process S2. changes D of the connection weights wc₁ to wcᵢ between before and after updating are measured. The changes D of the connection weights wc₁ to wcᵢ are measured, for example, by the evaluation circuit 40.

In the second process S2, it is determined whether the changes D of the connection weights wc₁ to wcᵢ between before and after updating are equal to or less than a threshold value Δ. When the changes D of the connection weights wc₁ to wcᵢ between before and after updating are equal to or less than the threshold value Δ, the output signal Sₒᵤₜ from the output layer 30 converges. When the changes D of the connection weights wc₁ to wcᵢ between before and after updating are equal to or less than the threshold value A, a third process S3 is performed. Each of the connection weights wc₁ to wcᵢ and the threshold value Δ may be set separately. When the changes D of the connection weights wc₁ to wcᵢ are greater than the threshold value Δ and the output signal Sₒᵤₜ from the output layer 30 diverges, the process flow returns to the first process S1, and the connection weights wc₁ to wcᵢ are updated.

In the third process S3, a distribution of the connection weights wc₁ to wcᵢ in the output layer 30 is calculated. The distribution of the connection weights wc₁ to wcᵢ is calculated by the evaluation circuit 40. The distribution of the connection weights wc₁ to wcᵢ is calculated by plotting the values of the connection weights on the horizontal axis and plotting the number of connection weights at a specific value on the vertical axis. The values of the connection weights wc₁ to wcᵢ are calculated, for example, by inputting the reference signal as described above.

Then, it is evaluated whether the distribution of the connection weights wc₁ to wcᵢ corresponds to a prescribed distribution. The prescribed distribution is, for example, a normal distribution, a uniform distribution, or a Laplacian distribution. The prescribed distribution varies according to a task given to the information processing device 100. The prescribed distribution is determined at a time point at which the task is determined and is stored in the evaluation circuit 40.

For example, when the prescribed distribution is a normal distribution, for example, it is determined, for example, on the basis of a Kolmogorov-Smirnov test or a Shapiro-Wilk test. When a P value of the distribution of the connection weights wc₁ to wcᵢ is less than 0.05, it can be determined that the distribution of the connection weights wc₁ to wcᵢ is not a normal distribution.

When the distribution of the connection weights wc₁ to wcᵢ corresponds to a prescribed distribution, adjustment parameters of the input layer 10 are determined in a fourth process S4. When the information processing device 100 exhibits a sufficient rate of correct answers after the adjustment parameters of the input layer 10 have been determined, learning ends. When the information processing device 100 does not exhibit a sufficient rate of correct answers after the adjustment parameters of the input layer 10 have been determined, the process flow returns to the first process S1, and the connection weights wc₁ to wcᵢ of the output layer 30 are updated.

On the other hand, when the distribution of the connection weights wc₁ to wcᵢ does not correspond to a prescribed distribution, the process flow proceeds to a fifth process S5. In the fifth process S5, it is determined whether the number of times of change of the adjustment parameters is equal to or greater than a prescribed number. The adjustment circuit 50 counts the number of times of change of the adjustment parameters. The prescribed frequency is appropriately determined depending on a task, accuracy of correct answers, a calculation load, and the like of the information processing device 100. The prescribed frequency is stored in the adjustment circuit 50.

When the number of times of change of the adjustment parameters is less than the prescribed number, the process flow proceeds to a sixth process S6, and the adjustment parameters of the input layer 10 are changed. The adjustment parameters are changed by the adjustment circuit 50. The adjustment circuit 50 changes, for example, the filter coefficients f₁ to fₙ. The adjustment circuit 50 may change, for example, the connection weights wa₁ to waₙ. The adjustment circuit 50 may change both the filter coefficients f₁ to fₙ and the connection weights way to wan.

For example, the adjustment circuit 50 sets a distribution of the adjustment parameters of the input layer 10 to a normal distribution. When the adjustment parameters are changed by the adjustment circuit 50 a plurality of times, an average or a variance is changed on the basis of the normal distribution.

For example, the adjustment parameters are adjusted at the first time by the adjustment circuit 50, the distribution of the adjustment parameters is set to a normal distribution with an average of 0 and a variance of 1. Then, when the adjustment parameters are adjusted at the second time or later by the adjustment circuit 50, the distribution of adjustment parameters is changed such that the variance increases. For example, when the adjustment parameters are changed at the n-th time, the variance is increased by 10% of the variance value at the (n−1)-th time.

The adjustment circuit 50 may set the distribution of adjustment parameters of the input layer 10 to a uniform distribution with a fixed random number width. When the adjustment parameters are changed by the adjustment circuit 50 a plurality of times, the random number width is changed.

For example, when the adjustment parameters are changed by the adjustment circuit 50 at the first time, the distribution of adjustment parameters is set to a uniform distribution with a random number width of ±0.1. When the adjustment parameters are adjusted at the second time or later by the adjustment circuit 50, the distribution of adjustment parameters is changed such that the random number width increases. For example, when the adjustment parameters are changed at the n-th time, the distribution is set to a uniform distribution with a random number width ±0.1×n.

On the other hand, when the number of times of change of the adjustment parameters is equal to or greater than the prescribed number, the adjustment parameters of the input layer 10 are not changed any more. When the number of times of change of the adjustment parameters is equal to or greater than the prescribed number, the process flow proceeds to a seventh process S7. In the seventh process S7, optimal adjustment parameters are selected as the adjustment parameters of the input layer 10 out of the changed adjustment parameters. The adjustment parameters when the rate of correct answers is the highest in the change history are selected as the optimal adjustment parameters.

Through this process flow, the information processing device 100 determines the connection weights wc₁ to wcᵢ of the output layer 30 and the adjustment parameters of the input layer 10 and ends the learning. In the arithmetic operation (inference) stage, the information processing device 100 performs an arithmetic operation using the connection weights wc₁ to wcᵢ of the output layer 30 and the adjustment parameters of the input layer 10 which are determined in the learning stage.

An example of the process flow performed by the information processing device 100 has been described above, but the process flow is not limited to this example. For example, when the distribution of the connection weights wc₁ to wcᵢ is evaluated whenever the connection weights wc₁ to wcᵢ are updated, the second process S2 may not be performed. When an upper limit of the number of times of change of the adjustment parameters is not set, the fifth process S5 and the seventh process S7 may not be performed.

The information processing device 100 according to this embodiment adjusts the adjustment parameters of the input layer 10 on the basis of the distribution of the connection weights wc₁ to wcᵢ of the output layer 30. The information processing device 100 can further enhance the rate of correct answers to a task by also adjusting the adjustment parameters of the input layer 10.

### REFERENCE SIGNS LIST

10 Input layer
11 Filter
12, 31 Bias applying unit
20 Reservoir layer
21 Node
30 Output layer
32 Sum operation circuit
33 Activation function circuit
40 Evaluation circuit
50 Adjustment circuit
60 Comparison circuit
70 Instruction circuit
100 Information processing device
f₁ to fₙ Filter coefficient
Sin₁ to Sinₙ Input signal
S1₁ to S1ₙ First signal
S2₁ to S2ᵢ Second signal
wa₁ to waₙ, wc₁ to wcᵢ Connection weight

1. An information processing device comprising:
an input layer;
a reservoir layer connected to the input layer and configured to generate a feature space including information of a first signal input from the input layer;
an output layer connected to the reservoir layer and configured to apply a connection weight to a second signal which is output from the reservoir layer;
an evaluation circuit configured to calculate a distribution of connection weights in the output layer and to evaluate whether the distribution of connection weights is a prescribed distribution; and
an adjustment circuit configured to change adjustment parameters for adjusting the first signal when the distribution of connection weights is not the prescribed distribution.

2. The information processing device according to claim 1, wherein the prescribed distribution is a normal distribution.

3. The information processing device according to claim 1, wherein the evaluation circuit evaluates whether the distribution of connection weights is a prescribed distribution when a change in connection weight between before updating and after updating is less than or equal to a prescribed value at the time of updating the connection weights applied to the second signal.

4. The information processing device according to claim 1, wherein the adjustment circuit selects an optimal adjustment parameter out of the changed adjustment parameters when the number of times of change of the adjustment parameters reaches a prescribed number.

5. The information processing device according to claim 1, wherein the adjustment parameters are connection weights which are multiplied by an input signal applied to the input layer.

6. The information processing device according to claim 1, wherein the adjustment parameters are filter coefficients of filters for selectively passing frequency components constituting an input signal applied to the input layer.

7. The information processing device according to claim 1, wherein a distribution of the adjustment parameters is a normal distribution.

8. The information processing device according to claim 1, wherein a distribution of the adjustment parameters is a uniform distribution
